(19) United States
(12) Patent Application Publication
(10) Pub. No.: US 2006/0023291 A1
(43) Pub. Date: Feb. 2, 2006

(54) Optical module

(75) Inventors: Takao Sakurai, Tokyo (JP); Koichiro Uekusa, Tokyo (JP)

Correspondence Address: OSHA LIANG L.L.P., 1221 MCKINNEY STREET, SUITE 2800, HOUSTON, TX, 77010, US

(73) Assignee: Advantest Corporation, Tokyo (JP)

(21) Appl. No.: 11/194,042

(22) Filed: Jul. 29, 2005

Related U.S. Application Data
(63) Continuation of application No. PCT/JP03/16877, filed on Dec. 26, 2003.

(30) Foreign Application Priority Data
Jan. 31, 2003 (JP) 2003-23008

(51) Int. Cl. G02F 1/11

(52) U.S. Cl. 359/286

(57) ABSTRACT

There is provided an optical module for output light produced by diffracting incident light inputted from the outside, having an acoustooptic device for emitting the diffracted light produced by diffracting the incident light at a different outgoing angle corresponding to wavelength of the incident light and a first correcting prism for compensating first output light in which the difference of the outgoing angles corresponding to the wavelength in the diffraction efficiency is reduced.

### CROSS REFERENCE TO THE RELATED APPLICATIONS

The present invention is a continuation application of PCT/JP03/16877 filed on Dec. 26, 2003, which claims priority from a Japanese Patent Application JP 2003-023008 filed on Jan. 31, 2003, the content of which is incorporated herein by reference as part of the description thereof.

### BACKGROUND OF THE INVENTION

1. Field of the Invention

The present invention relates to an optical module and more specifically to an optical module for output light produced by diffracting incident light inputted from the outside by an acoustooptic device.

2. Background Technology

Conventionally, there has been proposed a method for realizing optical modules such as an optical deflector, an optical modulator, an optical frequency shifter and an optical switch by using an acoustooptic device (Minoru Konuma, Shinya Yoshida, Mitsuyosi Shibata, “Opto-electronics and Its Materials” First Edition, Kogaku-Tosho Publishing Co., Jul. 15, 1995, pp. 219-223). In inputting/emitting light through optical fibers, it has been a general practice to configure the optical module using the acoustooptic device such that incident light inputted from the optical fiber on the input side is led to incident on the acoustooptic device via a collimator lens and diffracted light outgoing from the acoustooptic device is emitted to the optical fiber on the output side via a collimator lens.

The outgoing angle of the diffracted light outgoing from the acoustooptic device varies depending on wavelength of the incident light incident on the acoustooptic device. Therefore, the configuration described above has had a problem that when the collimator lenses are disposed at the optimum relative position and relative angle for the incident light of certain wavelength, a loss of the output light becomes significant when incident light having different wavelength is inputted.

### SUMMARY OF INVENTION

Accordingly, it is an object of the invention to solve such a problem.

In order to achieve such purpose, according to a first aspect of the invention, there is provided an optical module for output light produced by diffracting incident light inputted from the outside, having an acoustooptic device for emitting the diffracted light produced by diffracting the incident light with a different outgoing angle corresponding to wavelength of the incident light and a first correcting prism for compensating first output light in which the difference of the outgoing angle corresponding to the wavelength in the diffracted light is reduced.

The first correcting prism may emit the first output light produced by deflecting the diffracted light in the direction separating from an optical path of non-diffracted light outgoing without being diffracted among the incident light incident on the acoustooptic device.

The optical module may further include a first lens for emitting the first output light to an optical fiber connected to the optical module.

Still more, the optical module may include an incident prism for receiving the incident light and emitting it at a different angle corresponding to wavelength of the incident light to input the incident light to the acoustooptic device at an angle by which diffraction efficiency of the acoustooptic device increases.

The incident prism may deflect the incident light to an incident angle almost equal to Bragg diffraction angle to the acoustooptic device which is determined corresponding to the wavelength of the incident light to input it to the acoustooptic device.

The optical module may further include a second correcting prism for emitting second output light in which the difference of angles changed by the incident prism corresponding to the wavelength of incident light in non-diffracted light produced from the incident light incident on the acoustooptic device by the incident prism and emitted from the acoustooptic device without being diffracted is reduced as compared to the non-diffracted light.

Still more, the first correcting prism may emit the first output light in which the difference of outgoing angles corresponding the wavelength of the diffracted light is corrected to almost zero.

According to a second aspect of the invention, there is provided an optical module for output light produced by diffracting incident light inputted from the outside, including an acoustooptic device for emitting the diffracted light produced by diffracting the incident light at a different angle corresponding to wavelength of the incident light and an incident prism for inputting the incident light and emitting at different angles corresponding to wavelength of the incident light to input the incident light to the acoustooptic device at angle by which diffraction efficiency of the acoustooptic device increases.

It is noted that the summary of the invention described above does not necessarily describe all necessary features of the invention. The invention may also be a sub-combination of the features described above.

### BRIEF DESCRIPTION OF THE DRAWINGS

FIG. 1 shows a configuration of an optical module 100 according to an embodiment of the invention.

FIG. 2 is a graph showing one exemplary diffraction efficiency in an acoustooptic device 120 of the embodiment of the invention.

FIG. 3 is a graph showing one exemplary coupling loss at a first output lens 145 and a second output lens 155 of the embodiment.

FIG. 4 is a graph showing one exemplary insertion loss of first output light by the optical module 100 of the embodiment of the invention.

FIG. 5 is a graph showing a comparison result of the insertion loss of the first output light by the optical module 100 of the embodiment of the invention as compared with insertion loss of other methods.

FIG. 6 is a graph showing a difference of insertion loss between the first output light and the second output light by the optical module 100 of the embodiment of the invention.

### DETAILED DESCRIPTION OF THE INVENTION

One exemplary mode for carrying out the invention will now be explained with reference to the drawings.

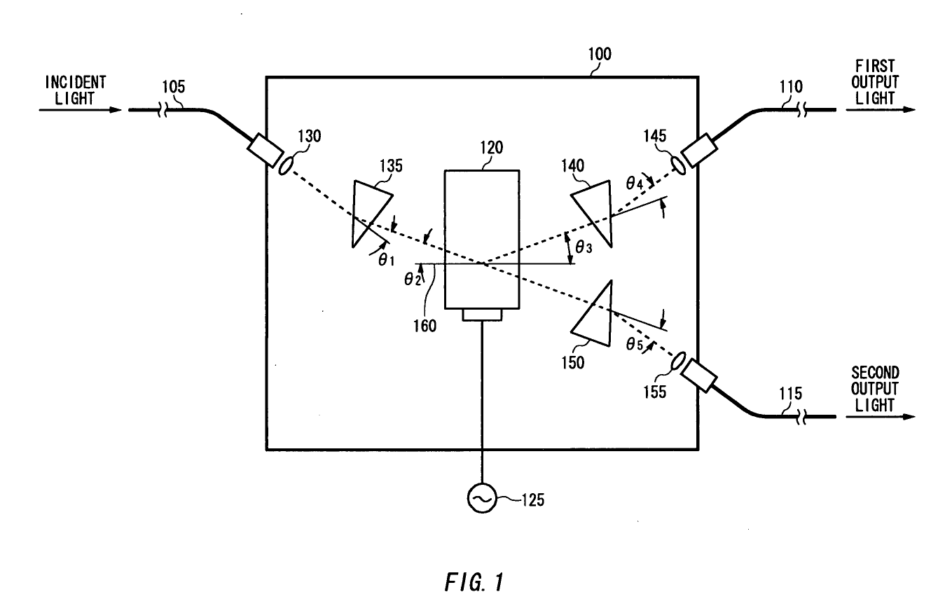

FIG. 1 shows a configuration of an optical module 100 according to the embodiment. The optical module 100 emits first output light produced by diffracting incident light, inputted from the outside via an input optical fiber 105, by an acoustooptic device 120 to a first output optical fiber 110 and emits second output light not diffracted by the acoustooptic device 120 among the incident light to a second output optical fiber 115. The purpose of the optical module 100 of the present embodiment is to adjust an incident angle at which the incident light is incident on the acoustooptic device 120 corresponding to wavelength of the incident light and to adjust an outgoing angle of the diffracted light outgoing from the acoustooptic device 120 which otherwise varies corresponding to the wavelength of the incident light to reduce a change of loss of the output light when the wavelength of the incident light is different.

The optical module 100 has an input lens 130, an incident prism 135, the acoustooptic device 120, a first correcting prism 140, a first output lens 145, a second correcting prism 150 and a second output lens 155. The input lens 130 corrects the incident light inputted via the input optical fiber 105 so as to be almost parallel incident light.

The incident light corrected by the input lens 130 is incident on the incident prism 135 and outgoes at a different angle corresponding to wavelength of the incident light. The incident prism 135 may be configured so as to deflect the incident light corrected by the input lens 130 by a deflection angle θ₁ in the direction closer to the acoustooptic device 120 to make an incident angle θ₂ at which the incident light is incident on the acoustooptic device 120 closer to zero. When the wavelength of the incident light is long in this case, the deflection angle θ₁ becomes smaller as compared to a case when the wavelength of the incident light is short. Thereby, the incident prism 135 causes the incident light corrected by the input lens 130 to be incident on the acoustooptic device 120 at an angle by which the diffraction efficiency of the acoustooptic device 120 increases.

The acoustooptic device 120 outputs the diffracted light produced by diffracting the incident light to the first correcting prism 140 at an outgoing angle θ₃ which varies corresponding to the wavelength of the incident light. More specifically, the acoustooptic device 120 is a device such as TeO₂, LiNbO₃ or PbMoO₄ for example that diffracts the incident light inputted from the incident prism 135 by periodic condensation and rarefaction of strain caused by supersonic applied from an oscillator 125. When the wavelength of the incident light is long here, the outgoing angle θ₃ becomes large as compared to the case when the wavelength of the incident light is short. The acoustooptic device 120 emits also non-diffracted light which is not diffracted by the acoustooptic device 120 among the incident light inputted from the incident prism 135 to the second correcting prism 150.

By receiving the diffracted light outgoing from the acoustooptic device 120, the first correcting prism 140 emits first output light in which the difference of the outgoing angle θ₃ corresponding to the wavelength of the diffracted light is reduced. More specifically, the first correcting prism 140 emits the first output light produced by deflecting the diffracted light outgoing from the acoustooptic device 120 by a deflection angle θ₄ in the direction separating from a supersonic wave plane 160 caused by the diffracted light. Thereby, the first correcting prism 140 emits the first output light produced by deflecting the diffracted light in the direction separating from an optical path of the non-diffracted light emitted without being diffracted among the incident light incident on the acoustooptic device 120.

When the wavelength of the incident light is long here, the outgoing angle θ₃ of the diffracted light becomes large as compared to the case when the wavelength of the incident light is short as explained before in connection with the acoustooptic device 120. Meanwhile, when the wavelength of the diffracted light is long, the deflection angle θ₄ becomes small as compared to the case when the wavelength of the diffracted light is short. Therefore, the first correcting prism 140 deflects the diffracted light, outgoing at the large outgoing angle θ₃ when the wavelength of the incident light is long, by the small deflection angle θ₄ in the same direction with the outgoing angle θ₃. Meanwhile, it deflects the diffracted light, outgoing at the small outgoing angle θ₃ when the wavelength of the incident light is short, by the large deflection angle θ₄ in the same direction with the outgoing angle θ₃. Thus, the first correcting prism 140 can reduce the difference of the outgoing angles corresponding to the wavelengths in the diffracted light outgoing from the acoustooptic device 120. The first correcting prism 140 may have an apex angle by which the sum of the outgoing angle θ₃ and the deflection angle θ₄ is almost zeroed in the wavelength range of the incident light in which the optical module 100 is used. In this case, the first correcting prism 140 can emit the first output light in which the difference of the outgoing angles corresponding to the wavelengths in the diffracted light outgoing from the acoustooptic device 120 is corrected to almost zero.

Still more, the first correcting prism 140 can increase a distance between the first output lens 145 and the second output lens 155 by deflecting the diffracted light in the direction separating from the optical path of the non-diffracted light.

The first output lens 145 emits the first output light deflected by the first correcting prism 140 to the first output optical fiber 110 connected to the optical module 100.

The second correcting prism 150 emits second output light in which the difference of the angles changed by the incident prism corresponding to the wavelength of the incident light in the non-diffracted light outgoing from the acoustooptic device 120 is reduced as compared to the non-diffracted light. More specifically, the second correcting prism 150 emits the second output light produced by deflecting the non-diffracted light outgoing from the acoustooptic device 120 by deflection angle θ₅ in the direction separating from the supersonic wave plane 160 caused by the diffracted light of the incident light. Thereby, the second correcting prism 150 emits the second output light produced by deflecting the non-diffracted light in the direction separating from the optical path of the diffracted light diffracted and emitted among the incident light incident on the acoustooptic device 120.

When the wavelength of the incident light is long here, the deflection angle θ₁ becomes small as compared to the case when the wavelength of the incident light is short as explained before in connection with the incident prism 135. Meanwhile, when the wavelength of the non-diffracted light that has passed through the acoustooptic device 120 without being diffracted among the deflected incident light is long, the deflection angle θ₅ becomes small as compared to the case when the wavelength of the non-diffracted light is short. Accordingly, the second correcting prism 150 deflects the non-diffracted light outgoing at the small deflection angle θ₁ when the wavelength of the incident light is long by the smaller deflection angle θ₅ in the direction opposite to that of the deflection angle θ₁. Meanwhile, it deflects the non-diffracted light outgoing at the smaller outgoing angle θ₃ when the wavelength of the incident light is short by the larger deflection angle θ₅ in the direction opposite from that of the deflection angle θ₁. Thereby, the second correcting prism 150 can reduce the difference of the outgoing angles that is changed by the incident prism 135 corresponding to the wavelength of the incident light in the non-diffracted light outgoing from the acoustooptic device 120. Still more, the second correcting prism 150 may have an apex angle by which the deflection angle θ₁ and the deflection angle θ₅ becomes almost equal in the wavelength range of the incident light in which the optical module 100 is used. In this case, the second correcting prism 150 can correct the difference of the outgoing angles changed by the incident prism 135 corresponding to the wavelength of the incident light in the non-diffracted light outgoing from the acoustooptic device 120 to almost zero.

Still more, the second correcting prism 150 can increase the distance between the second output lens 155 and the first output lens 145 by deflecting the non-diffracted light in the direction separating from the optical path of the diffracted light.

The second output lens 155 emits the second output light deflected by the second correcting prism 150 to a second output optical fiber 115 connected to the optical module 100.

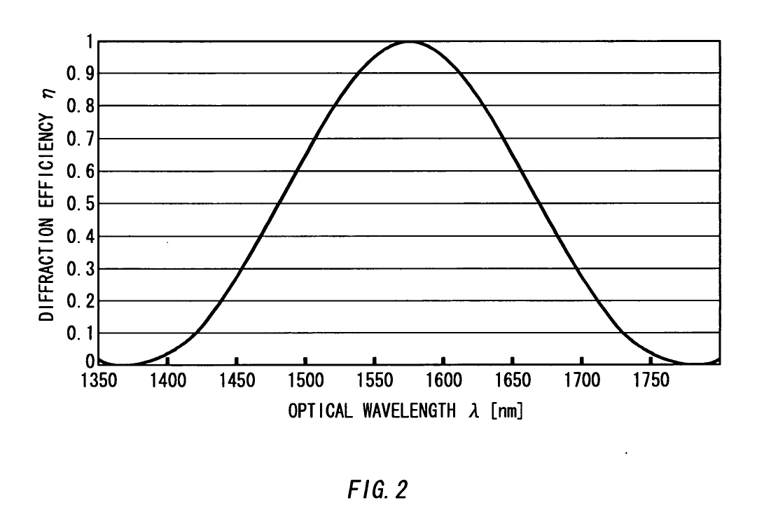

FIG. 2 is a graph showing one exemplary diffraction efficiency in the acoustooptic device 1200f the embodiment. More specifically, it shows the wavelength dependency of the diffraction efficiency when the incident light is inputted to the acoustooptic device 120 with an incident angle by which the diffraction efficiency is maximized when the wavelength of the incident light is 1570 nm in case when supersonic of 150 MHz is applied to the acoustooptic device 120 of PbMoO₄.

The optical module 100 of the present embodiment has the incident prism 135 for correcting the incident angle of the incident light incident on the acoustooptic device 120 to reduce the wavelength dependency of the diffraction efficiency. Bragg diffraction angle θ_{B} which is an incident angle by which the diffraction efficiency θ_{B} is maximized may be approximated by the following equation (1):

$${θ}_{B} = {SIN}^{- 1} ( \frac{λ}{2 Λ} ) \qquad ( 1 )$$

where λ is the wavelength of the incident light and Λ is the wavelength of the supersonic in the acoustooptic device 120.

When the center of the wavelength range of the incident light to the optical module 100 is denoted as λ_{c}, the incident angle of the incident light to the incident prism 135 and the apex angle of the incident prism 135 are adjusted so that the incident light of the center wavelength λ_{c} is inputted to the acoustooptic device 120 at an angle almost equal to the Bragg diffraction angle determined the equation (1) corresponding to the center wavelength λ_{c}. Still more, as for a variation of the deflection angle Δθ₁=λ₁ (λ)−θ₁ (λ_{c}) caused by the incident prism 135 and a variation of the Bragg diffraction angle Δθ_{B}=θ_{B} (λ)−θ_{B} (λ_{c}) of the acoustooptic device 120 when incident light having wavelength λ different from the center wavelength is inputted, the material or the apex angle of the incident prism 135 is adjusted so that Δθ₁ is almost equalized to Δθ_{B} in the wavelength range of the incident light to the optical module 100 for example. Thereby, the incident prism 135 can deflect the incident light to have the incident angle almost equal to the Bragg diffraction angle to the acoustooptic device 120 which is defined corresponding to the wavelength of the incident light and can input it to the acoustooptic device 120.

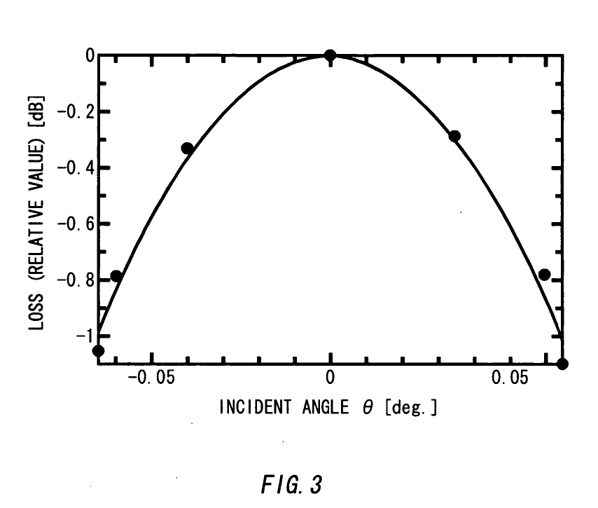

FIG. 3 is a graph showing one exemplary coupling loss at the first and second output lenses 145 and 155 of the present embodiment. More specifically, FIG. 3 shows results of optical coupling loss found by experiments when light is inputted to a collimating lens with a different incident angle by relative values to optical coupling loss when light is inputted at incident angle zero.

Here, an angle β for diffracting by Bragg diffraction within the crystal of the acoustooptic device 120 may be expressed by the following equation (2):

$$β \approx \frac{λ}{Λ \cdot n} - α \qquad ( 2 )$$

where α is the incident angle of the light within the crystal of the acoustooptic device 120 and n is the refractive index of the acoustooptic device 120.

When the speed of sound is denoted as v and oscillating frequency of the oscillator 125 as fs, the wavelength of the supersonic within the acoustooptic device 120 is v/fs, so that the equation (2) may be transformed into the following equation (3):

$$β \approx \frac{λ \cdot {f}_{s}}{v \cdot n} - α \qquad ( 3 )$$

Accordingly, the relationship between the incident angle θ₂ to the acoustooptic device 120 and the outgoing angle θ₃ from the acoustooptic device 120 may be expressed by the Snell's law, as follows:

$${θ}_{3} \approx \frac{λ \cdot {f}_{s}}{n} - {θ}_{2} \qquad ( 4 )$$

The equation (4) above enables one to calculate that when the supersonic of 150 MHz is applied to the acoustooptic device 120 made from PbMoO₄, about 0.13 degree of angular change occurs when the wavelength range of the incident light is 1520 to 1620 nm. When the first correcting prism 140 is not provided, it can be seen from FIG. 3 that the wavelength dependency of the coupling loss reaches to more than about 1 dB in the range from the wavelength range of 1520 to 1620 nm.

Meanwhile, as for a variation of the outgoing angle Δθ₃=θ₃ (λ)−θ₃ (λ_{c}) of the acoustooptic device 120 and a variation of the deflection angle Δθ₄=θ₄ (λ)−θ₄ (λ_{c}) in the first correcting prism 140 when incident light having wavelength λ different from the center wavelength is inputted, the material or apex angle of the first correcting prism 140 is adjusted so that Δθ₃ is almost equalized to −Δθ₄ in the wavelength range of the incident light to the optical module 100 for example. Thereby, the first correcting prism 140 can correct the difference of the outgoing angles corresponding to the wavelength of the diffracted light outgoing from the acoustooptic device 120 to almost zero. It is noted that when the incident prism 135 is not provided, α in the equation (3) and θ₂ in the equation (4) become fixed values based on the angle when the incident light is inputted from the input optical fiber 105 to the optical module 100. When the incident prism 135 is provided on the other hand, those values change so that the value of α becomes the Bragg diffraction angle determined corresponding to the wavelength of the incident light. At this time, the material or the apex angle of the first correcting prism 140 may be adjusted so that the difference of the outgoing angles corresponding to the wavelength in the diffracted light caused by the incident prism 135 and the acoustooptic device 120 is reduced or is almost zeroed as compared to the diffracted light.

For instance, in correcting the incident light whose wavelength is 1520 to 1620 nm when the supersonic of 150 MHz is applied to the acoustooptic device 120 made from TeO₂, a prism of flint grass (F2) having an apex angle of 60 to 70 degrees, or more preferably almost 64 degrees, may be used as the first correcting prism 140. Here, an angle of beam of the first output light emitted from the first correcting prism 140 to the first output lens 145 does not change and moves in parallel by a small amount even when the wavelength is changed. Here, the collimator lens causes small change of coupling loss to the parallel move of the inputted beam and the coupling loss barely fluctuates by the parallel move of around 100 μm for example. Accordingly, the first correcting prism 140 can output the diffracted light diffracted by the acoustooptic device 120 to the first output optical fiber 110 with the constant coupling loss independent of the wavelength.

In the same manner, as for the variation of the outgoing angle Δθ₁=θ₁ (λ)−θ₁ (λ_{c}) of the incident prism 135 and a variation of the deflection angle in the second correcting prism 150 Δθ₅=θ₅ (λ)−θ₅ (λ_{c}) when the incident light having wavelength λ different from the center wavelength is inputted, the material or apex angle of the second correcting prism 150 is adjusted so that Δθ₁ is almost equalized to Δθ₅ in the wavelength range of the incident light to the optical module 100 for example. Thereby, the second correcting prism 150 can correct the difference of the outgoing angles changed by the incident prism 135 corresponding to the wavelength of the incident light in the non-diffracted light outgoing from the acoustooptic device 120 to almost zero.

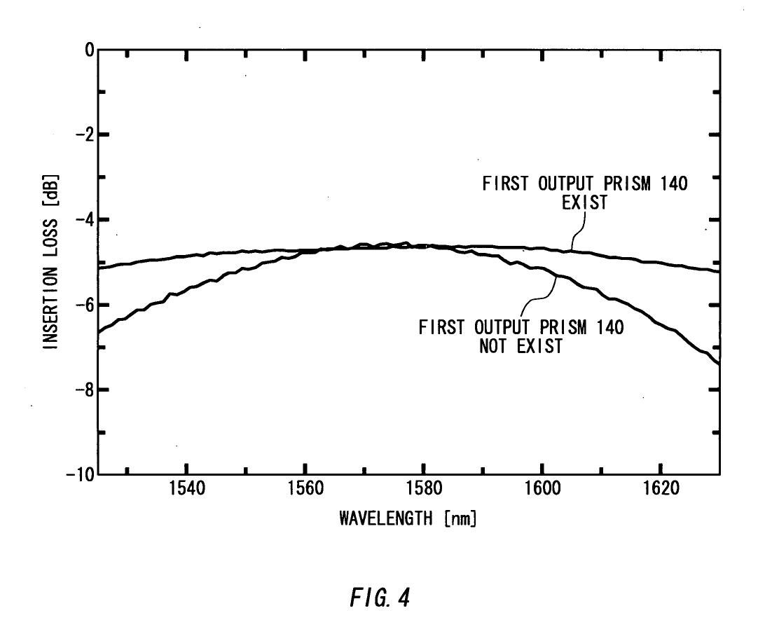

FIG. 4 is a graph showing one exemplary insertion loss of the first output light by the optical module 100 of the present embodiment. FIG. 4 shows here the result measured by experiments on the coupling loss of the first output optical fiber 110 in cases when the first correcting prism 140 is provided and is not provided when the incident prism 135 is not provided, i.e., the insertion loss when the first output light is inserted into the first output optical fiber 110. As shown in FIG. 4, it can be seen that the wavelength dependency of the insertion loss decreases from around 2 dB to around 0.6 dB in the wavelength range of 1520 to 1620 nm by providing the first correcting prism 140. The insertion loss shown in FIG. 4 may be reduced further by providing the incident prism 135.

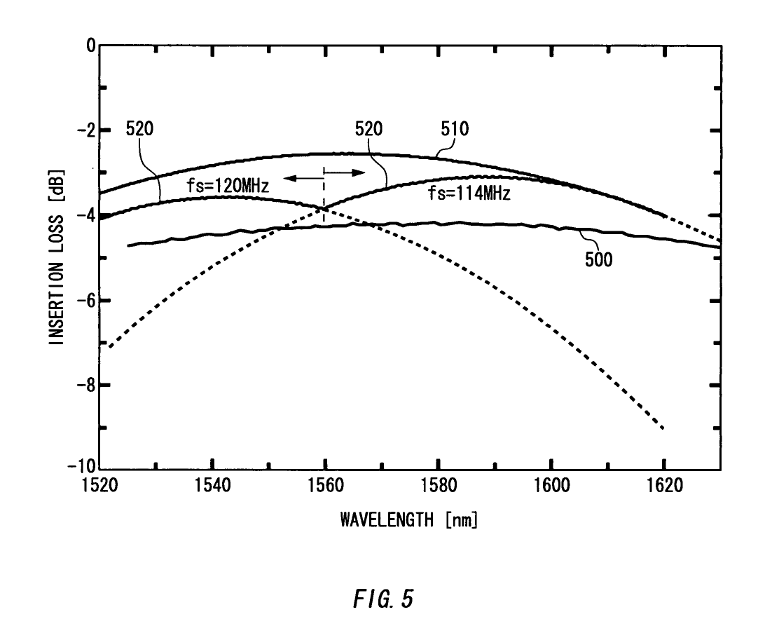

FIG. 5 is a graph showing a comparison result of the insertion loss of the first output light by the optical module 100 of the present embodiment as compared to insertion losses of other methods. An insertion loss A500 indicates the result, measured by experiments, of the insertion loss of the first output light in the case when the incident prism 135 is not provided in the optical module 100 of the present embodiment. An insertion loss B510 indicates the result, measured by experiments, of an insertion loss in a mode when the wavelength dependency of the Bragg diffraction angle in the equation (1) is reduced by using the acoustooptic device such as TeO₂ whose supersonic propagating speed is high in the case when the incident prism 135 and the first correcting prism 140 are not provided. An insertion loss C520 indicates the result, measured by experiments, of an insertion loss in a mode when the frequency fs of the supersonic generated by the oscillator 125 is changed corresponding to the wavelength of the incident light in the case when the incident prism 135 and the first correcting prism 140 are not provided.

As compared to the insertion losses B510 and C520, the wavelength dependency of the insertion loss A500 is small and it may be reduced further by providing the incident prism 135 in the optical module 100. Still more, in the mode of the insertion loss C520, the outgoing angle from the acoustooptic device 120 corresponding to the wavelength of the incident light varies corresponding to changes of frequency of the supersonic, so that it is difficult to use it in measurements requiring high wavelength precision such as measurement of wavelength dispersion. Still more, enough accuracy may not be obtained when the frequency of the supersonic is generated by VOC or the like.

However, the wavelength dependency of the insertion loss A500 may be suppressed low in the optical module 100 even when the frequency of the supersonic is fixed, so that it becomes possible to attain both the reduction of the wavelength dependency of the insert ion loss and the maintenance of the high wavelength accuracy.

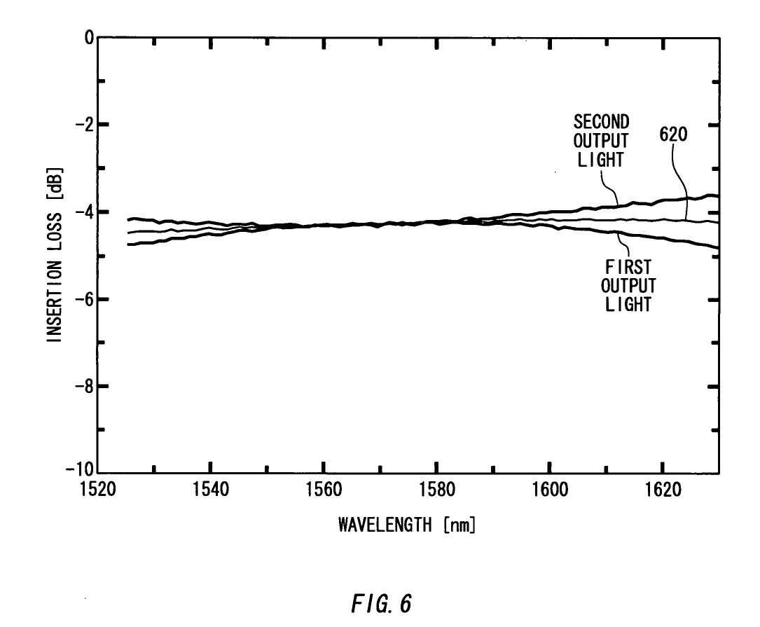

FIG. 6 is a graph showing the difference of insertion loss between the first output light and the second output light by the optical module 100 of the present embodiment. Here, FIG. 6 shows the results, measured by experiments, of the insertion loss of the first output light emitted to the first output optical fiber 110 and the second output light to the second output optical fiber 115 in the case when the incident prism 135 is not provided. An average insertion loss 620 indicates an average insertion loss of the first and second output lights.

The optical module 100 of the present embodiment can suppress the difference of the insertion loss of the first and second output lights to be low in the wavelength range of the incident light of 1520 to 1620 nm as shown in FIG. 6.

Although the invention has been described by way of the exemplary embodiments, it should be understood that those skilled in the art might make many changes and substitutions without departing from the spirit and scope of the invention. It is obvious from the definition of the appended claims that the embodiments with such modifications also belong to the scope of the invention.

For instance, the optical module 100 may be configured so as not to include the incident prism 135 and the second correcting prism 150, so as not to include the first correcting prism 140 and the second correcting prism 150 or so as not include either one of the first correcting prism 140 and the second correcting prism 150. Still more, the incident prism 135, the first correcting prism 140 and the second correcting prism 150 may be realized by optical systems that output incident light at different angle corresponding its wavelength.

As it is apparent from the above explanation, the invention allows the change of loss of the output light caused when the wavelength of the incident light varies to be reduced in the optical module for output light produced by diffracting the incident light.

What is claimed is:

1. An optical module for output light produced by diffracting incident light inputted from the outside, comprising:
an acoustooptic device for emitting the diffracted light produced by diffracting said incident light at a different outgoing angle corresponding to wavelength of said incident light; and
a first correcting prism for compensating first output light in which the difference of the outgoing angle corresponding to the wavelength in said diffracted light is reduced.

2. The optical module as set forth in claim 1, wherein said first correcting prism compensates said first output light as said diffracted light diffracted in larger angle to the direction of and optical path of non-diffracted light emitted from said acoustooptic device without being diffracted.

3. The optical module as set forth in claim 1, further comprising a first lens for introducing said first output light to an optical fiber connected to said optical module.

4. The optical module as set forth in claim 1, further comprising an incident prism for refracting said incident light at and emitting it at a different angle corresponding to wavelength of said incident light to input said incident light to said acoustooptic device at an angle by which diffraction efficiency of said acoustooptic device increases.

5. The optical module as set forth in claim 4, wherein said incident prism deflects said incident light to an incident angle almost equal to Bragg diffraction angle of said acoustooptic device which is determined corresponding to the wavelength of said incident light to input it to said acoustooptic device.

6. The optical module as set forth in claim 4, further comprising a second correcting prism for emitting second output light in which the difference of angles varied by said incident prism corresponding to the wavelength of incident light in non-diffracted light of said incident light inputted to said acoustooptic device by said incident prism and emitted from said acoustooptic device without being diffracted is reduced as compared to said non-diffracted light.

7. The optical module as set forth in claim 1, wherein said first correcting prism outputs said first output light in which the variation of outgoing angle corresponding to said wavelength of said diffracted light is reduced by correction to almost zero.

8. An optical module for output light produced by diffracting incident light inputted externally, comprising:
an acoustooptic device for emitting the diffracted light produced by diffracting said incident light at a different outgoing angle corresponding to wavelength of said incident light; and
an incident prism for receiving said incident light and emitting at a different angle corresponding to wavelength of said incident light to input said incident light to said acoustooptic device at an angle by which diffraction efficiency of said acoustooptic device increases.
